(19) United States
(12) Patent Application Publication
(10) Pub. No.: US 2004/0072647 A1
(43) Pub. Date: Apr. 15, 2004

(54) Components system for engaging a standard differential

(76) Inventor: Christos Valasopoulos, Athens (GR)

Correspondence Address: HORST KASPER, 13 FOREST DRIVE, WARREN, NJ, 07059, US

(21) Appl. No.: 10/457,667

(22) Filed: Jun. 9, 2003

Related U.S. Application Data
(63) Continuation-in-part of application No. PCT/GR01/00033, filed on Sep. 6, 2001.

(30) Foreign Application Priority Data
Dec. 8, 2000 (GR) 20000100424

(51) Int. Cl. F16H 48/06

(52) U.S. Cl. 475/231

(57) ABSTRACT

A differential braking component comprises a shaft having a shaft axis to be placed substantially perpendicular to a wheel axis of a differential and to an idler axis of the differential, a bevel gear casing rotatably surrounding the shaft and having a geared outer surface for engaging a side gear of a wheel axis and having an associated inner surface, and a conical ring surrounding the shaft and disposed slidable in the direction of the shaft on the shaft and disposed fixed with respect to relative angle on the shaft and having an outside disposed along an inside of the bevel gear casing following the geared outer surface. A spring ring surrounds the shaft outside of an area of the conical ring and serving to press the conical ring against the associated inner surface of the bevel gear casing. A first safety pin restrains the spring ring from moving away from the conical ring.

### BACKGROUND OF THE INVENTION

1. Field of the Invention

The present differential relates to the construction, operation and application of differentials used in all types of wheeled vehicles, in particular of differential such as employed in connection with drive axles of motor vehicles.

2. Brief Description of the Background of the Invention Including Prior Art

A split casing limited slip differential mechanism is taught in European Application AP0939246. A transmission of power to both wheel axles through a pair of small toothed gears (pinions), supported by two free engaging axles, a pair of side toothed gears, a clutch mechanism with multiple disks furnished between the split mechanism casing and a thrust ring is achieving a limitation of the movement of the side gears, when the thrust ring, moves to an axial outwards direction.

The international application WO 00/3/37830 teaches a differential, which can be used as a standard differential or as a limited slip differential. The mechanism transmits the power through a small gear (pinion) on the input power axle to a pair of output power axles and comprises a casing, a toothed ring seated on the casing and rotating through the pinion around the differential longitudinal axis, a spoked component with a number of leys, on which a pair of spoked gears is seated, which move two side gears furnished each on the two output axles so that the motion of the wheels is controlled. The U.S. Pat. No. 3,548,683 teaches a gear mechanism with an oscillating inner ring, which is furnished between the two side gears in a kinetic meshing with said gears so that an inertia force is introduced on each of the side aligned output power axles.

The international-patent papers WO 88/05139, WO 9612124, the patents U.S. Pat. No. 4,291,591, EP 0670439 teach several mechanisms, with oscillating components, rolling elements and reciprocating movements, which are considered non comparable to the present invention.

The Torsen type differentials are a specific and peculiar planetary gear system. In the center of the system, worm gears form the output towards the axles, while on their perimeter and the inside of the casing three pairs of shafts are fitted with gears meshing with the sun gear disposed on the central axis of the gear train and between the gears.

In case of a conventional differential, it is well known that the sum of the speed on both wheels attached to the two sides of the differential is constant under a specific number of revolutions per minute of the engine.

The sum of the speeds of two wheels of a conventional differential is directly proportional to the rotation speed of the motor shaft, Consequently, when both driving wheels are in traction on the pavement, with a different coefficient of friction (p), then one wheel will accelerate and the other will decelerate with the well known undesirable effects. The one wheel with the lower adhesion or traction will spin, whereas the other wheel does not turn at all.

Under these conditions, the power transmitted by friction forces of the differential on both wheel is minimal and the vehicle is brought to a standstill.

When the wheel lacking traction spins, the wheel with traction will stop and there with the whole motor vehicle will stop.

To overcome this difficulty, various differential types of limited slip were developed, which aim at improving the adhesion, with the variation of torque distribution, on the wheel with the greatest adhesion. While the conventional differential has a ratio of torque distribution 50:50 i.e., ratio of torque distribution 1:1 or sometimes 1,5:1 the limited slip differential alters this torque distribution in favor of the axle with the greater adhesion or traction to the ratio 80:20 or 4:1 and in some cases 6:1. In spite of that, said differentials exhibit several disadvantages, such as premature wear of the system, due to the high friction forces and the resulting high temperatures leading to the premature failure of the system. Other disadvantages are its heavy weight, high inertia forces and the big number of components used.

### BRIEF DESCRIPTIONS OF THE INVENTION

The present invention furnishes a differential braking component including a shaft having a shaft axis to be placed substantially perpendicular to a wheel axis of a differential and to an idler axis of the differential, a bevel gear casing rotatably surrounding the shaft and having a geared outer surface for engaging a side gear of a wheel axis and having an associated inner surface, and a conical ring surrounding the shaft and disposed slidable in the direction of the shaft on the shaft and disposed fixed with respect to relative angle on the shaft and having an outside disposed along an inside of the bevel gear casing following the geared outer surface. A spring ring surrounds the shaft outside of an area of the conical ring and serving to press the conical ring against the associated inner surface of the bevel gear casing. A first safety pin restrains the spring ring from moving away from the conical ring. The first safety pin is supported by the bevel gear casing. A second safety pin can be attached to the shaft.

A first friction ring is disposed between an outer end surface of the conical ring and an inner surface of the spring ring and surrounds the shaft and rotates together with the bevel gear casing. The first friction ring and the bevel gear casing are furnished with matching recesses and projections.

A second friction ring is disposed between an outer end surface of the first friction ring and an inner surface of the spring ring and surrounding the shaft, disposed stationary relative to the shaft, and disposed inside of the bevel gear casing. The second friction ring and the shaft are furnished with matching recesses and projections.

Another first friction ring can be disposed between an outer end surface of the second friction ring and an inner surface of the spring ring and surrounding the shaft and rotating together with the bevel gear casing.

A second friction ring can be disposed between an outer end surface of the conical ring and an inner surface of the spring ring and surrounding the shaft, disposed stationary relative to the shaft, and disposed inside of the bevel gear casing and a first friction ring can be disposed between an outer end surface of the second friction ring and an inner surface of the spring ring and surrounding the shaft and rotating together with the bevel gear casing. The shaft is preferably disposed perpendicular to an intersection of the wheel axis and of the idler axis of a differential and wherein the shaft is stationary. A wheel axis of a differential can be mounted to the shaft and an idler axis of a differential can be mounted to the shaft. The bevel gear casing can include a first step surrounding the conical ring and carrying the outer geared surface, and a second sep having a larger diameter than the first step and surrounding the spring ring. A centrifugal pump full of lubricating oil can be disposed on an end of the shaft. An angle of the bevel of the outer gear surface is from about 20 to 40 degrees.

The present invention introduces a system of components assembled in a planetary mechanism of a conventional differential, said system drastically reduces said disadvantages and allows in the case of adhesion loss of one driving wheel the variation of power distribution in favor of the wheel with the higher adhesion.

It comprises a properly configured shaft inserted inside the one piece or split casing of a standard in use differential, the pin of the standard differential inserted through a hole drilled transversally in the center of said shaft, on both ends of said pin are assembled the two bevel gears, through which power is transmitted and through the meshing of side bevel gears, the output shafts are rotating. The two ends of said shaft are configured as splines, wherein a bevel gear casing is assembled with its teeth meshing with the two side gears of the differential.

A spline is any of a series of uniformly spaced ridges on a shaft and disposed parallel to the axis of the shaft and fitting inside corresponding grooves in the hub of a gear or the like to transmit torque.

In the bore hole of said bevel gear casing, one at least conical ring is assembled with inner teeth matching the splines of said shaft ends, one at least spring ring of predetermined thickness and spring characteristic, one at least friction ring with inner teeth and one at least friction ring with outer teeth matching respectively the splines of said shaft and the inner teeth of said bevel gear casing. The bevel gear casing element with the components, as described, assembled in its inner space, along with said shaft inserted in the standard differential, achieve in the case of adhesion loss of one wheel the increase of the mechanism engagement and the transmission of the remaining torque, or the whole torque, to the wheel with the greatest adhesion, on the other hand it allows the variation of the mechanism engagement degree through the combination of the following selective modifications in the construction of said elements a) the variation of the fit angle of the bevel gear casing on the properly configured shaft, b) the number of friction rings and c) the thickness and the spring characteristic of the spring ring.

It should be noted that the operation of the engagement mechanism can be achieved by the application on the properly configured shaft of two at least friction rings without the use of the conical ring.

In said system of engagement components, on the extension, of said properly configured shaft and inside the bevel gear casing a lube oil centrifugal pump can be added, wherein with the operation of said pump a further resistance to the rotation of the mechanism is added, with result a further increase of its engagement.

The said briefly described system and its embodiments compared to a standard differential, apart from the important advantage of the engagement achieved, and the change in torque distribution in the cases of adhesion loss, has the additional advantage of increasing the torque bias due to the ratio of meshing teeth of the bevel gear and the side gear. Also, the application of this system succeeds in reducing the wear of the differential mechanism, due to the distribution of loads during operation to more components, namely gears, pinions, rings.

The component system is easily assembled with the mechanism of the standard in use planetary system differentials inside the existing one piece or split casing for almost all the vehicle types. The manufacturing of the system components is easily executed with the usual manufacturing processes for the standard in use components and the assembly and disassembly of the system does not require exceptionally skilled personnel. The cost for in series production of said components is minimal compared to the cost of the limited slip differential mechanisms and systems in use and its weight significantly lower.

### BRIEF DESCRIPTION OF THE DRAWINGS

The following description of the drawings wherein like numerals are used to designate like parts of the specific forms embodied in spirit and essential characteristics of this invention and to be considered in all respects as illustrative and no restrictive there of.

FIG. 1 is a cross section of a standard in use differential, assembled with the set of components of the present invention.

FIG. 2 is a front view, side view and down view of a shaft properly configured on its center and both ends, assembled in the standard differential in FIG. 1.

FIG. 3 is a front view and the down view of a friction ring with internal teeth.

FIG. 4 is a front view and the down view of a friction ring with external teeth.

FIG. 5 is a front view and down view of a spring ring.

FIG. 6 is a front view and down view of a conical ring.

FIG. 7 is a front view and the down view of a bevel gear casing, fitted on the shaft shown in FIG. 1. Inside said bevel gear casing the components shown in FIG. 3,4,5,6.

FIG. 8 is a sectional view of the invention brake.

FIG. 9 is a sectional view of the differential.

FIG. 10 is a detailed view showing the section of the braking disk.

FIG. 11 is a sectional view of the centrifugal pump.

FIG. 12 is a sectional view of the embodiment of FIG. 11. along section lines B-B′ FIG. 13 is a sectional view showing the brake and the wheel access.

### DETAILED DESCRIPTION OF DRAWINGS

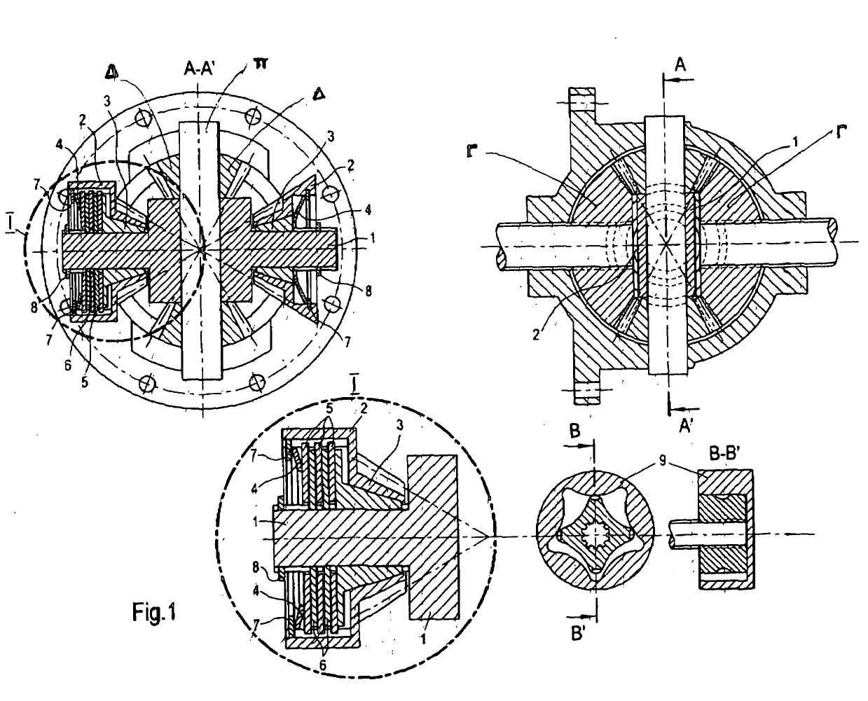

Referring to FIGS. 1,2,3,4,5,6,7 an application is presented a system of engagement components, introduced within a standard differential, comprising a properly configured shaft 1, one at least small bevel gear casing 2, one at least conical ring 3, one at least spring ring 4, one at least friction ring with external teeth 5, one at least friction ring with internal teeth 6, safety rings 7,8, a centrifugal pump 9.

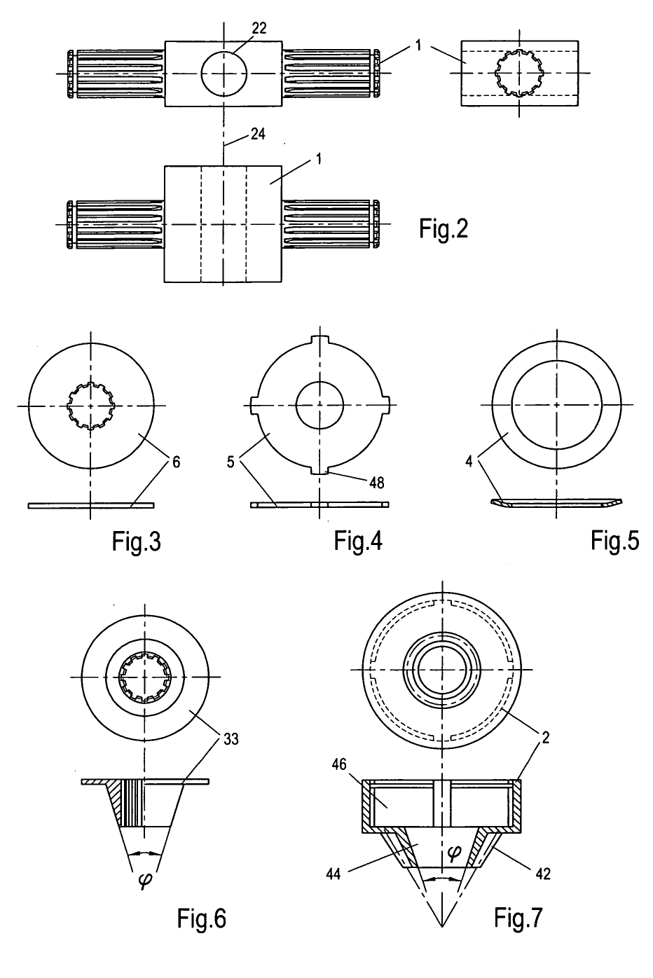

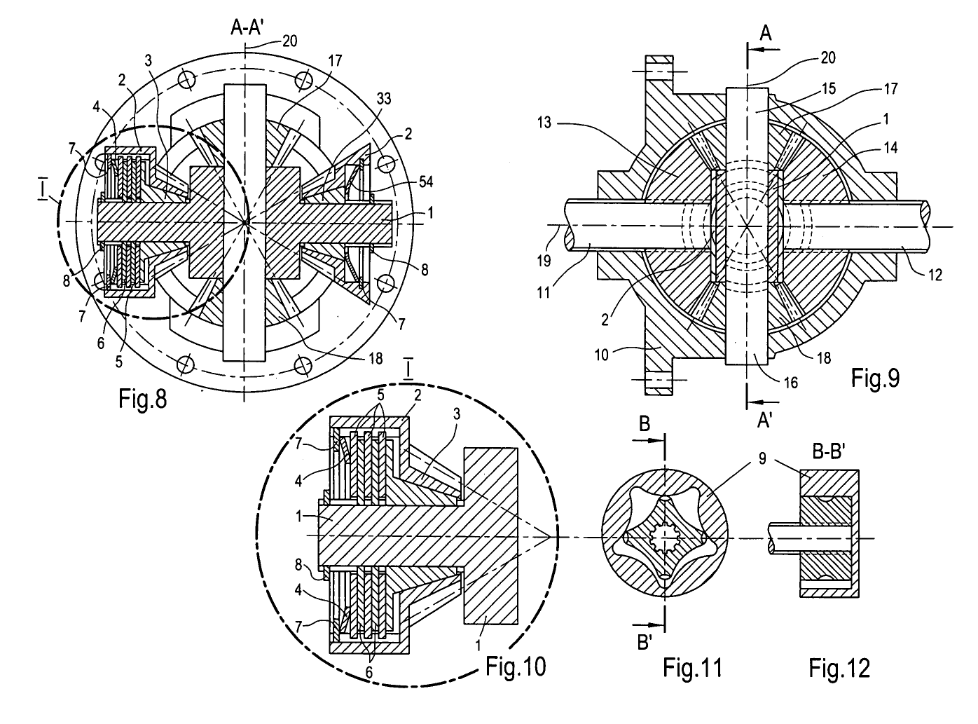

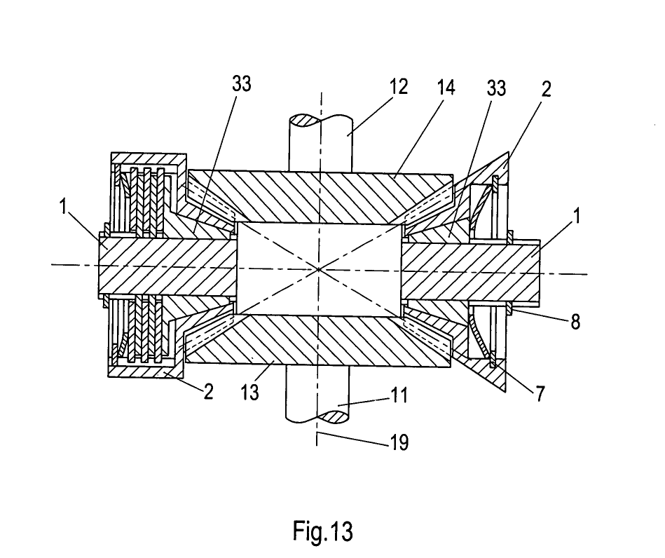

The elements of the engagement components system are presented separately in FIG. 2,3,4,5,6,7 while in FIG. 1 an assembled system of engagement components inside the casing of a standard differential is presented, wherein two bevel gears Δ on a pin receiving the motion along the input power shaft transmit it through the two meshing side gears Γ to the output shaft.

FIGS. 1,2 are views of a shaft (1) introduced in the center of the casing along an axis perpendicular to the vertical axis of pin Π. The shaft 1 is configured in its middle part as a parallelepiped on with a borehole drilled in its center, wherein the pin Π is inserted (FIGS. 1,2). The ends of shaft 1 are machined as splines.

FIG. 3 is a view of a friction ring 6 with inner teeth matching the splines on shaft ends 1 (FIG. 2).

FIG. 4 is a view of a friction ring 5 with outer teeth matching the teeth on the bevel gear casing 2 (FIG. 7).

FIG. 5 is a view of a spring ring 4 fitted inside the bevel gear casing 2.

FIG. 6 is a view of a conical ring 3 with inner teeth fitted on shaft 1 and in the inside surface of the bevel gear casing 2.

FIG. 7 is a view of a small bevel gear casing 2 which matches the splined ends of shaft 1 (FIG. 1), wherein its inner surface is conical with a desired angle T, matching the conical ring 3. Said casing (2), apart from the outer teeth which engage it with the side gears teeth, has in its inner surface, inner teeth.

The elements of the system 2,3,4,5,6 as presented in FIG. 1 inside said casing 2 has been previously assembled on shaft 1 in the following order:

Friction ring 6 is fitted with its inner teeth matching the splined ends of the shaft, friction ring 5 is fitted on shaft 1 in contact with ring 6, while the outer teeth of said ring are matching the inner teeth of gear casing 2, spring ring 4 is fitted on shaft tin contact and under pressure from rings 5,6 and the conical ring 3 is fitted inside the shaft and the casing in contact with ring 5. The packing of the series of said elements 2,3,4,5,6 is secured with an adequate number of safety pins (7,8). The centrifugal pump 9 (FIG. 1) assembled if required on the extension of shaft 1 increases the engagement capability of the system.

The application of the components of the system as described previously and shown in FIG. 0.1 achieves, during the vehicle movement in the case of adhesion loss of one driving wheel, the increase of the differential mechanism engagement, due to the simultaneously produced increase of pressure and friction action during the rotation of the conical ring 3 and spring ring 4 inside the bevel gear casing on the one hand, and on the other hand of the friction rings 5,6, which produces a relevant jamming of the rotation of the small bevel gear casing 2 meshing with the side gears Γ of the differential, wherein in this manner an analog increase of the mechanism engagement degree is achieved dependent at first on the adhesion loss percent. Apart from that, the reduction of the angle size of the inner conical surface of the bevel gear casing 2 or/and the increase of the number of the friction rings 5, 6 controls the desired mechanism engagement degree increase. In extreme cases a centrifugal pump 9 assembled on the end of shaft 1 operating in lube oil can further increase the system engagement.

In combination with the previous mentioned an additional increase of torque bias is achieved due to the ratio of meshing teeth of the bevel gear to the teeth of the side gear which is 1 to 1,4 up to 1,6.

The present invention is based on a standard differential with wheel axle shafts 11, 12 having a wheel axis 19 and carrying side gears 13, 14 and with idler shafts 15, 16 having an idler axis 20 carrying side bevels 17, 18. A shaft 1 is disposed preferably substantially perpendicular to the wheel axis 19 and to the idler axis 20. The shaft 1 is furnished with a bore hole 22 in the center for passage of an idler axle 24. Each side of the shaft 1 is furnished with projections elongated in a direction parallel to the shaft 1 for defining an angular position of a conical ring 3, 33 to be slid onto a respective end of shaft 1. The conical ring 3, 33 can be disposed slidable on the shaft 1. Furthermore, one or more second friction rings 6 having recesses on the inner ring surface matching projections on the outer wall of shaft 1 are placed onto at least one end of shaft 1.

A gear casing 2 surrounds a respective end shaft 1, the respective conical ring 3, 33 and the respective one or more second friction rings 6. The gear casing 2 is furnished on the outside with a gear surface 42 suitable to engage the side gears 13, 14. The inside of the gear casing 2 is adapted to slide over the outside of the conical ring 3. The gear casing 2 is formed in two steps with a first narrower step 44 surrounding the conical ring 3, 33 and with a second step 46 having a larger inner diameter surrounding the second friction rings 6. The inner surface of the second step is furnished with inner projections or recesses, which are to engage respective recesses or projections 48 of first friction rings 5 surrounding the shaft 1. The first friction rings 5 and the second friction rings 6 are placed in an alternating sequence. A spring ring 4, 54 is placed at a respective outer end of the shaft 1 contacting the outermost one of the first or second friction rings 5, 6. The spring ring 4, 54 is held in position by a first safety pin 7 attached on the insider of the second step of the gear casing 2. A second safety pin 8 is disposed near a respective outer end of the shaft 1.

Alternatively, the first friction disks 5 and the second friction disks 6 can be dispensed with and the spring ring 4 and directly contact an outer end face of the conical ring 33.

When the side gears 13, 14 engage the gear surface 42 of the gear casing 3, the gear surface 42 will exert a braking force on the side gears 13, 14, wherein the speed reduction of the respective side gear caused by the gear casing 3 is the larger the larger the speed of the side gear 13, 14. Thus the wheel experiencing loss of adhesion is baked substantially mot by the differential braking component of the present invention.

It is obvious that in the light of this description various modifications and structural changes may be made, consequently within the limits of amended claims, where reference to numbers is merely a helping tool and are not in anyway binding, the present invention may be applied in a different way than this specific description.

1. Components system for engaging a standard differential comprising one shaft (1) inserted in the center of the casing (10) of a standard differential mechanism, one bevel gear casing (2) adapted on shaft (1) whose teeth are meshing with the teeth of the side gears (1) of the standard differential, two at least friction rings (5,6) with external and internal teeth respectively, adapted to the shaft (1) inside the bevel gear casing (2), one at least spring ring (4) adapted on said shaft inside said bevel gear casing, one at least conical ring (3) with inner teeth fitted on shaft (1) inside said bevel gear casing, one centrifugal pump (9) full of lubricating oil adopted on the end of shaft (1), wherein the shaft (1) is inserted in the center of the casing of a standard differential mechanism along an axis perpendicular to the pin (Π) which bears the two bevel gears (Δ) through which power is transmitted along the input power shaft and wherein said shaft (1) is configured in its middle section as a parallelepipedon with a borehole drilled in its center through which the pin (Π) of the standard differential is inserted and wherein said shaft (1) is splin end on both ends, wherein one said friction ring is adapted and one said conical ring and wherein all said system elements are assembled on said shaft (1) and inside the bevel gear casing (2), wherein the whole element system in the case of adhesion loss of one driving wheel, and the resulting from that pressure on the series of said elements achieve through the engaged teeth of the small bevel gear casing (2) and the side gears (Γ) the increase of the mechanism engagement and the resulting torque distribution variation in favor of the wheel with the, higher traction and wherein an additional increase of the torque bias is achieved due to the ratio of the bevel gears and side gears' meshing, teeth which is 1 to 1,4 up to 1,6.

2. Components system for engaging a standard differential according to claim 1, wherein the fit angle cp of the inner conical surface of the bevel gear casing (2), where the conical ring (3) is adapted, determines the desired engagement degree of the system.

3. Components system for engaging a standard differential according to claims 1,2 wherein the bevel gear casing has internal teeth where the external teeth of the friction rings (5) adapted on shaft (1) are matching.

4. Components system for engaging a standard differential according to claim 1 wherein one centrifugal pump (9) full of lubricating oil adapted on the end of shaft (1) inside bevel gear casing (2) allows the further increase of the system engagement.

5. Components system for engaging a standard differential according to claim 1,2,3,4 wherein the whole set of the components of the system adapted on shaft (1), is fitted inside the bevel gear casing (2).

6. A differential braking component comprising
a shaft having a shaft axis to be placed substantially perpendicular to a wheel axis of a differential and to an idler axis of the differential;
a bevel gear casing rotatably surrounding the shaft and having a geared outer surface for engaging a side gear of a wheel axis and having an associated inner surface;
a conical ring surrounding the shaft and disposed slidable in the direction of the shaft on the shaft and disposed fixed with respect to relative angle on the shaft and having an outside disposed along an inside of the bevel gear casing following the geared outer surface;
a spring ring surrounding the shaft outside of an area of the conical ring and serving to press the conical ring against the associated inner surface of the bevel gear casing;
a first safety pin restraining the spring ring from moving away from the conical ring.

7. The differential braking component according to claim 6 wherein the first safety pin is supported by the bevel gear casing and further comprising a second safety pin attached to the shaft.

8. The differential braking component according to claim 6 further comprising
a first friction ring disposed between an outer end surface of the conical ring and an inner surface of the spring ring and surrounding the shaft and rotating together with the bevel gear casing.

9. The differential braking component according to claim 8 wherein the first friction ring and the bevel gear casing are furnished with matching recesses and projections.

10. The differential braking component according to claim 8 further comprising
a second friction ring disposed between an outer end surface of the first friction ring 3 and an inner surface of the spring ring and surrounding the shaft, disposed stationary relative to the shaft, and disposed inside of the bevel gear casing.

11. The differential braking component according to claim 10 wherein the second friction ring and the shaft are furnished with matching recesses and projections.

12. The differential braking component according to claim 10 further comprising
another first friction ring disposed between an outer end surface of the second friction ring and an inner surface of the spring ring and surrounding the shaft and rotating together with the bevel gear casing.

13. The differential braking component according to claim 6 further comprising
a second friction ring disposed between an outer end surface of the conical ring 3 and an inner surface of the spring ring and surrounding the shaft,
disposed stationary relative to the shaft, and disposed inside of the bevel gear casing,
a first friction ring disposed between an outer end surface of the second friction ring and an inner surface of the spring ring and surrounding the shaft and rotating together with the bevel gear casing.

14. The differential braking component according to claim 6 wherein the shaft is disposed perpendicular to an intersection of the wheel axis and of the idler axis of a differential and wherein the shaft is stationary.

15. The differential braking component according to claim 6 further comprising
a wheel axis of a differential mounted to the shaft;
an idler axis of a differential mounted to the shaft.

16. The differential braking component according to claim 6 wherein the bevel gear casing includes
a first step surrounding the conical ring and carrying the outer geared surface;
a second step having a larger diameter than the first step and surrounding the spring ring.

17. The differential braking component according to claim 6 further comprising
a centrifugal pump full of lubricating oil disposed on an end of the of the shaft.

18. The differential braking component according to claim 6 wherein an angle of the bevel of the outer gear surface is from about 20 to 40 degrees.
